(19) United States
(12) Patent Application Publication
(10) Pub. No.: US 2025/0096294 A1
(43) Pub. Date: Mar. 20, 2025

(54) MARINE ONBOARD CARBON CAPTURE USING MOLTEN CARBONATE FUEL CELLS

(71) Applicant: EXXONMOBIL TECHNOLOGY AND ENGINEERING COMPANY, Spring, TX (US)

(72) Inventors: Aaron SATTLER, Annandale, NJ (US); Matthew S. Mettler, Flemington, NJ (US); Anastasios I. Skoulidas, Pittstown, NJ (US); Clay R. Sutton, Pittstown, NJ (US); Kenneth C.H. Kar, Yardley, PA (US)

(21) Appl. No.: 18/883,198

(22) Filed: Sep. 12, 2024

Related U.S. Application Data
(60) Provisional application No. 63/582,562, filed on Sep. 14, 2023.

(51) Int. Cl. H01M 8/0668; H01M 8/04014; H01M 8/0612; H01M 8/14

(52) U.S. Cl. CPC H01M 8/0668; H01M 8/04022; H01M 8/0618; H01M 8/145; H01M 2008/147; H01M 2250/20

(57) ABSTRACT

Systems and methods are provided for using molten carbonate fuel cells (MCFCs) to reduce, minimize, and/or avoid CO₂ emissions in a marine vessel environment. The systems and methods can include operation of MCFCs on a marine vessel under high fuel utilization conditions in order to provide power and capture CO₂. The high fuel utilization conditions can allow for mitigation of CO₂ over extended periods of time in spite of the challenges of performing CO₂ mitigation in a potentially isolated environment such as a marine vessel. Additionally, the high fuel utilization can also reduce or minimize exhaust of fuels, such as methane, to the environment.

### CROSS REFERENCE TO RELATED APPLICATION

This Non-Provisional patent application claims priority to U.S. Provisional Patent Application No. 63/582,562, filed Sep. 14, 2023, and titled “Marine Onboard Carbon Capture Using Molten Carbonate Fuel Cells”, the entire contents of which is incorporated herein by reference.

### FIELD OF THE INVENTION

Systems and methods are provided for operating and performing CO₂ capture in a marine environment using molten carbonate fuel cells.

### BACKGROUND OF THE INVENTION

The International Maritime Organization (IMO) has an initial strategy for greenhouse gas emission reduction of 50% by 2050. One option for attempting to meet this goal for greenhouse gas emissions is to perform carbon capture. The current state of the art commercially for removing CO₂ from a combustion flue gas is to use aqueous amines. However, there are difficulties with attempting to incorporate aqueous amine capture technology into a marine environment. For example, large scale aqueous amine capture systems typically include a series of contacting towers that are used for cooling, CO₂ capture, and washing of the gas exiting from the CO₂ capture stage. The contacting towers include packing material that provides additional surface area for supporting thin films and/or droplets of liquids that are used in the cooling, CO₂ capture, and washing stages. The size of these contacting towers (including the vertical footprint) is not readily compatible with incorporation into a marine vessel, and the towers also add weight, thus reducing the available carrying capacity of the marine vessel. Additionally, the towers can impact the stability of a vessel. Addition of towers to a marine vessel corresponds to adding a substantial amount of weight with a center-of-mass that is relatively high. Addition of large amounts of mass at height to a marine vessel can be destabilizing when a ship heels. If capture is to be used for mitigation of CO₂ emissions from marine vessels, improvements in capture technology will be desirable.

U.S. Patent Application Publication 2015/0252269 describes methods of integrating molten carbonate fuel cells with Fischer-Tropsch synthesis methods.

U.S. Patent Application Publication 2017/0271701 describes methods for integrated operation of molten carbonate fuel cells under conditions involving both high fuel utilization and high CO₂ utilization.

U.S. Patent Application Publication 2020/0176795 describes combustion of fuel components in an anode exhaust using an oxygen storage component as the oxygen source for the combustion reaction.

A 2021 joint report from the Oil and Gas Climate Initiative (OGCI) and Stena Bulk titled “Is Carbon Capture on Ships Feasible?”, evaluates several carbon capture technologies for use in a marine environment, including aqueous amine capture.

### SUMMARY OF THE INVENTION

In some aspects, a method for operating a molten carbonate fuel cell is provided. The method can be used, for example, for operating a molten carbonate fuel cell on a marine vessel. The method includes providing a cathode input flow containing 3.0 vol % or more CO₂ and at least 1.5 vol % O₂ to a cathode of a molten carbonate fuel cell. The method further includes providing an anode input flow containing H₂, reformable hydrocarbons, or a combination thereof to an anode of the molten carbonate fuel cell. Additionally, the method includes operating the molten carbonate fuel cell at a CO₂ utilization of 70% or less, a fuel utilization of 80% or more, and a current density of 100 mA/cm² or more to generate electrical power and to produce a cathode output flow and an anode output flow.

In some aspects, the CO₂ utilization can be 55% or less. In some aspects, the fuel utilization can be 90% or more.

In some aspects, the cathode input flow can include 0.01 vol % to 0.5 vol % of nitrogen oxides and/or 0.005 vol % to 0.1 vol % of hydrocarbons. In such aspects, the cathode output flow can include less than 0.01 vol % of nitrogen oxides and/or less than 0.005 vol % of hydrocarbons.

### BRIEF DESCRIPTION OF THE FIGURES

FIG. 1 shows an example of a configuration for operating a molten carbonate fuel cell in a marine vessel environment.

FIG. 2 shows a general example of a portion of a molten carbonate fuel cell stack.

FIG. 3 shows CO₂ capture, production, and exhaust rates for various marine vessel configurations.

FIG. 4 shows CO₂ capture and avoidance metrics for various marine vessel configurations.

FIG. 5 shows CO₂ capture and avoidance metrics for various marine vessel configurations.

FIG. 6 shows fuel efficiency for various marine vessel configurations.

FIG. 7 shows excess fuel required for carbon capture for various marine vessel configurations.

FIG. 8 shows CO₂ emitted per unit of fuel energy consumed for various marine vessel configurations.

### DETAILED DESCRIPTION OF THE EMBODIMENTS

### Overview

In various aspects, systems and methods are provided for using molten carbonate fuel cells (MCFCs) to reduce, minimize, and/or avoid CO₂ emissions in a marine vessel environment. The systems and methods can include operation of MCFCs on a marine vessel under high fuel utilization conditions in order to provide power and capture CO₂. The high fuel utilization conditions can allow for mitigation of CO₂ over extended periods of time in spite of the challenges of performing CO₂ mitigation in a potentially isolated environment such as a marine vessel. Additionally, the high fuel utilization, optionally in combination with low CO₂ utilization conditions, can also reduce or minimize exhaust of fuels, such as methane, to the environment.

Conventionally, a variety of options are available for mitigation of CO₂ emissions from large sources, such as flue gases from large engines and/or power plants. This allows solutions such as aqueous amine capture to be used, which involve both large horizontal footprints and large vertical footprints. For such conventional solutions, any power required to operate the CO₂ capture systems can be provided on-site (possibly as part of the additional footprint for installation) or obtained from the local power grid. Additionally, once CO₂ is separated from a gas in a conventional installation, a variety of options are available for longer term sequester, as pipelines and/or other types of transport are available to carry CO₂ away from the local site.

Unlike conventional applications for performing CO₂ capture, performing CO₂ mitigation in a marine vessel environment can pose a variety of challenges. First, unlike a conventional facility, the available space on a marine vessel is limited, both in terms of horizontal and vertical footprint. It is noted that aqueous amine capture systems typically include a series of large towers to perform flue gas cooling, CO₂ capture via contact with the aqueous amine, and then washing of the CO₂-depleted gas to remove any entrained amine. Due to the limited space available on a marine vessel, the limits in total weight requirements, and the potential destabilization that can be caused by adding large amounts of mass at elevated heights, such large scale additions to the equipment footprint (both horizontal and vertical) are undesirable in a marine vessel context.

Second, because a marine vessel has limited volume and weight capacity, adding additional equipment that requires power creates additional difficulties due to the need to store and purchase extra fuel. Additionally, since many types of CO₂ equipment are driven primarily by electrical power, additional on-board generators are also required. This further reduces the available volume and weight capacity for transporting cargo on a marine vessel.

Still another issue is handling of CO₂ once it is separated from the exhaust of the marine engines and/or generators. Because marine vessels primarily operate far from shore, the opportunities for transfer of CO₂ to a sequestration facility are limited. This means that any CO₂ captured in a marine vessel environment needs to be stored on the vessel itself. Unfortunately, CO₂ is substantially heavier on a per carbon basis than the hydrocarbonaceous fuels that are typically used as fuels in a marine vessel. As an example, methane (a primary component of natural gas) has a molecular weight of roughly 16. Combustion of one methane molecule results in formation of one carbon dioxide molecule that has a molecular weight of roughly 44. Thus, if a marine vessel attempts to capture all of the CO₂ generated from combustion of fuels on the marine vessel, each 1.0 grams of fuel that is combusted (or other unit of weight) results in roughly 2.7 to 3.2 grams of CO₂ that needs to be sequestered. Typically, consumption of fuel results in a marine vessel becoming lighter. But if a marine vessel attempts to capture all of the CO₂ generated from the engines, the ship would actually get heavier as fuel is consumed, resulting in an additional constraint on the amount of available weight for cargo.

In various aspects, one or more of the above difficulties can be reduced or mitigated by using molten carbonate fuel cells for carbon capture. This can include operating the MCFCs under high fuel utilization conditions. By operating under high fuel utilization conditions, the amount of methane and hydrogen in the anode exhaust of the MCFC can be reduced or minimized, while also reducing or minimizing the excess fuel requirements for operating the MCFC. Another benefit of using MCFCs for CO₂ capture is that the MCFCs can provide electrical power for the marine vessel. Thus, instead of needing additional generators to operate the carbon capture system, using MCFCs to perform carbon capture can potentially reduce the number of generators needed on a vessel. In some aspects, further benefits can be obtained by operating the MCFCs to capture only a portion of the CO₂ generated by the engines of the marine vessel. Under the standards proposed by the International Maritime Organization (IMO), the target is to reduce CO₂ emissions by 50%. In some aspects, this can correspond to operating the MCFCs with a CO₂ utilization that is lower than expected, such as having a CO₂ utilization of 65% or less. By capturing only a portion of the CO₂ emissions from the marine vessel, the weight gain from performing CO₂ sequester can be reduced or minimized while still providing sufficient CO₂ capture to meet upcoming regulatory standards.

Molten carbonate fuel cells utilize hydrogen and/or other fuels to generate electricity. The hydrogen may be provided by reforming methane, ethane, propane, butanes, natural gas, liquefied petroleum gas (LPG), liquefied natural gas (LNG), or mixtures thereof, or other reformable fuels in a steam reformer, such as steam reformer located upstream of the fuel cell or integrated within the fuel cell. Another option can be to include reforming elements that are integrated with a fuel cell stack. Fuel can also be reformed in the anode cell in a molten carbonate fuel cell, which can be operated to create conditions that are suitable for reforming fuels in the anode. Still another option can be to perform some reforming both externally and internally to the fuel cell. Reformable fuels can encompass hydrocarbonaceous materials that can be reacted with steam and/or oxygen at elevated temperature and/or low or high pressure to produce a gaseous product that comprises hydrogen.

The basic structure of a molten carbonate fuel cell includes a cathode, an anode, and a matrix between the cathode and anode that includes one or more molten carbonate salts that serve as the electrolyte. During conventional operation of a molten carbonate fuel cell, the molten carbonate salts partially diffuse into the pores of the cathode. This diffusion of the molten carbonate salts into the pores of the cathode provides an interface region where CO₂ can be converted into CO₃²⁻ for transport across the electrolyte to the anode.

Traditionally, molten carbonate fuel cells have been operated for production of electrical power under conditions corresponding to 45% to 75% fuel utilization. This choice was made based on several factors. First, traditional operation of a fuel cell involved combusting the remaining fuel in the anode effluent to form CO₂, and then using the anode effluent as the cathode input to provide CO₂ for operation of the fuel cell. Operating at 45% to 75% fuel utilization allowed sufficient fuel to remain in the anode effluent so that sufficient CO₂ could be formed. The combustion reaction also provided heat to assist with maintaining the temperature of the fuel cell. Still another aspect of choosing this fuel utilization was that it allowed for stable generation of electrical power with regard to maintaining operating voltage and current density.

### High Fuel Utilization, Low CO₂ Utilization Operation in Marine Environment

In various aspects, instead of operating a fuel cell under conventional conditions, a molten carbonate fuel cell for use in a marine environment can be operated at higher fuel utilization, such as a fuel utilization of 80% or more, or 85% or more, or 90% or more, such as up to 98% or possibly still higher. In some aspects, this elevated fuel utilization can be paired with a relatively low CO₂ utilization, such as a CO₂ utilization of 70% or less, or 60% or less, or 55% or less, or 50% or less, such as down to 40% or possibly still lower.

In a marine vessel environment, a variety of advantages can be achieved by operating a MCFC for CO₂ mitigation under high fuel utilization conditions. These advantages can include reduced or minimized exhaust and/or storage of unburned fuel components as well as reduced or minimized requirements for on-board storage of fuel. Furthermore, substantially all of the CO₂ produced from the reforming of the fuel cell fuel is captured, in addition to the intended CO₂ capture of the marine engine exhaust.

In a marine vessel environment, it is beneficial to reduce or minimize the amount of unburned fuel in the anode exhaust from an MCFC. Methane is a common component for fuels introduced as part of the anode input for an MCFC. Such methane can be part of a methane or natural gas feedstock, or methane can be formed by pre-reforming of a hydrocarbon feed (such as a diesel feed) in order to form the anode input flow. Thus, at conventional fuel utilizations of roughly 75% or less, typically a portion of this methane passes through the MCFC into the anode exhaust. Additionally, at conventional fuel utilizations, any reformed products that have fuel value (such as CO and H₂) that are not consumed for fuel cell power generation are also passed out of the fuel cell in the anode exhaust. In a marine vessel environment, however, it is desirable to reduce or minimize the fuel remaining in the anode exhaust. For example, methane is a potent greenhouse gas, so it can be beneficial to reduce or minimize methane in the anode exhaust. As another example, although it is undesirable to have unreacted fuel components that are sequestered with the CO₂, as a practical matter removing unreacted fuel from the anode exhaust is difficult in a marine vessel environment. Thus, unconsumed fuel in the anode exhaust adds to costs for compression of the anode exhaust prior to storage, as well as adding weight to the final stored product without gaining the benefit of power generation. As an alternative, additional separations could be performed to try to recycle the unburned fuel, but this would substantially add to equipment while likely resulting in little or no extra power generation beyond the power needed for the separation(s) and recycle. Still another option could be to combust any fuel remaining in the exhaust for additional heat generation. This could be achieved, for example, using a burner, or by oxidation using a chemical looping system using an oxygen storage component as the source of oxygen for combustion. Again, this would add more equipment and more equipment footprint, for at best modest gains. Additionally, such combustion/oxidation of the fuel in the anode exhaust would also result in either a) combusting excess fuel prior to separation, resulting in heating of the anode exhaust prior to storing the CO₂, thus further increasing the energy requirements for achieving the desired temperature and pressure for storing the CO₂, or b) combusting the excess fuel after separating the CO₂ from the anode exhaust for sequestration, thus creating a new source of CO₂ that either escapes to the environment or has to be captured.

In various aspects, the above difficulties with managing an anode output flow in a marine vessel environment can be reduced or minimized by operating an MCFC with a fuel utilization of 80% or more, or 85% or more, or 90% or more, such as up to 98% or possibly still higher. By operating at higher fuel utilization, the equilibrium methane reforming performed within the fuel cell anode can be driven substantially closer to completion. While some hydrogen can remain in the anode output flow, such higher fuel utilization allows the methane content of the anode exhaust to be reduced to 0.5 vol % or less, or 0.1 vol % or less, such as down to having substantially no methane content (0.01 vol % or less). Additionally or alternately, the hydrogen (H₂) content of the anode output flow under high fuel utilization conditions can be 5.0 vol % or less, or 4.0 vol % or less, or 2.5 vol % or less, or 1.0 vol % or less, such as down to 0.1 vol % or possibly still lower. It is noted that at such low levels, these “impurities” can be captured with the CO₂ and treated on land, rather than requiring being treated on the marine vessel. Further additionally or alternately, the CO content of the anode output flow under high fuel utilization conditions can be 1.5 vol % or less, or 1.0 vol % or less, or 0.5 vol % or less, such as down to 0.1 vol % or possibly still lower.

In addition to mitigating CO₂, using MCFCs for carbon capture can also mitigate NOx emissions from a marine vessel. Nitrogen oxides can also be used to form anions that transport across the electrolyte in an MCFC. After reaching the anode, the nitrogen oxides can be converted to N₂ under the reducing conditions present in the anode. In some aspects, the input flow for the cathode can include 0.01 vol % to 0.5 vol % of nitrogen oxides. In such aspects, 40 wt % or more of the nitrogen oxides in the cathode input flow can be transferred to the anode output flow, or 50% or more, such as up to 80% or possibly still more. Additionally or alternately, in such aspects, the cathode output flow can include less than 0.05 vol % of nitrogen oxides, or less than 0.01 vol %, such as down to substantially no content of nitrogen oxides (less than 0.005 vol %). In this discussion, the amount of nitrogen oxides transferred into the anode output flow can be determined by measurement of the total nitrogen oxide content in the cathode input flow and the total nitrogen oxide content in the cathode output flow. Any reduction in the total amount of nitrogen oxides corresponds to nitrogen oxides transported across the electrolyte and into the anode output flow. It is noted that such nitrogen oxides will be converted into N₂ in the anode.

In addition to removal of nitrogen oxides, MCFCs can also reduce or minimize methane slip and/or other hydrocarbon slip in a flue gas from a combustion engine. In some instances, the flue gas from a combustion engine, such as the engine of a marine vessel, can include small amounts of methane and/or other hydrocarbons that were not combusted within the engine. The cathode of a MCFC operates at greater than 500° C. The interface of the cathode with the electrolyte typically corresponds to a porous material, such as a porous nickel cathode. Metals such as nickel can catalyze a combustion reaction for residual hydrocarbons that may be present in a flue gas from the engine of a marine vessel. In aspects where hydrocarbons are present in the flue gas from a marine vessel engine, a cathode input stream can include 0.005 vol % to 0.1 vol % of a hydrocarbon, such as methane. Due to the presence of oxygen in the cathode input stream, and the presence of a cathode material that can catalyze a combustion reaction, such hydrocarbons can be combusted in the cathode to reduce the hydrocarbon content in the cathode exhaust down to having substantially no hydrocarbons (less than 0.005 vol %).

In some aspects, operating MCFCs with high fuel utilization (and optionally low CO₂ utilization) can also assist with the specialized factors related to managing CO₂ emissions (and/or other emissions) for a marine vessel. Due to potential upcoming international regulations, it will be beneficial for marine vessels to be able to continuously mitigate CO₂ during extended periods of time when the marine vessel may not have access to land-based facilities and/or fuel tenders. This means that a marine vessel will need to be able to store captured CO₂ that is removed from the engines and/or generators of the marine vessel. However, because the weight of a CO₂ molecule is roughly three times as great as the typical —CH₂— groups that are the dominant form of carbon in many types of fuels, the weight of the captured CO₂ is also a concern, as a ship storing sequestered CO₂ will actually get heavier as fuel is consumed, rather than lighter.

In addition to operating with high fuel utilization and low CO₂ utilization, the total CO₂ captured can be further managed by processing only a portion of the flue gases generated on a marine vessel. In various aspects, there may be multiple options for achieving a total reduction in CO₂ emissions of roughly 50% for a marine vessel. One option can be to process all of the flue gas generated by a vessel, with a CO₂ utilization rate in the MCFCs of roughly 50%. Another option can be to process 80% of the flue gases, with a CO₂ utilization rate in the MCFCs of roughly 60%. Still other combinations of the amount of flue gas processed and the CO₂ utilization can be used to achieve a target level of CO₂ mitigation. For example, in some aspects, 50 vol % to 90 vol % of the flue gases generated by a marine vessel (by engines, diesel generators, and/or any other combustion sources) can be processed as part of cathode input flows in an MCFC, or 70 vol % to 90 vol %, or 50 vol % to 80 vol %, or 50 vol % to 70 vol %.

Operating with high fuel utilization and low CO₂ utilization has traditionally been viewed as undesirable for any of the traditional applications involving molten carbonate fuel cells. These traditional applications include power generation, carbon capture, and hydrogen product.

In a conventional power generation context, fuel utilizations near 65% to 75% are preferred for at least two separate reasons. First, during conventional power generation, the anode exhaust is used as the input flow (or at least a portion of the input flow) for the cathode. Thus, it is desirable to have excess fuel in the anode output that can be combusted to provide both heat for maintaining the temperature of the fuel cell, as well as additional CO₂ for the cathode. Second, Operating at fuel utilizations between 65% and 75% represents a stable operating region for a fuel cell with respect to the operating voltage. Outside of this 65% to 75% fuel utilization range, the operating voltage versus fuel utilization curve has significantly steeper slopes, meaning that small variations in fuel utilization can lead to larger variations in the resulting operating voltage (and corresponding variations in the amount of power generated). For large scale power generation, such a drop in operating voltage is undesirable, as it lowers the overall efficiency in providing power. Additionally, for large scale power generation, even small variations in power generation can correspond to substantial variations in the amount of fuel needed and/or the number of units needed to match the required power load at any given time. Thus, for conventional power generation, to provide stable operation in delivering power, and to provide sufficient CO₂ for cathode operation, it has been desirable to operate between 65% to 75% fuel utilization.

In contrast to a conventional power generation situation, on a marine vessel, the total power requirements for the vessel are limited. Increasing the fuel utilization to 80% or more can result in less stability for operating voltage and/or power generation per unit of fuel, but these variations can be more readily managed on the smaller scale of the power systems for a single marine vessel. Additionally, in a marine vessel context, high fuel utilization provide the advantage of reducing or minimizing the amount of fuel remaining in the anode exhaust. Unlike a commercial power generation site, the anode exhaust is not used to provide CO₂ for the cathode. By contrast, in various aspects, operating MCFCs at high fuel utilization reduces or minimizes the amount of fuel remaining in the anode exhaust. This both reduces the amount of fuel required for operation of the MCFCs to generate power, and reduces or minimizes the release of unburned fuel to the environment. In some aspects, MCFCs can be operated to provide electrical power at a current density of 60 mA/cm² or more, or 100 mA/cm² or more, or 150 mA/cm² or more, such as up to 200 mA/cm² or possibly still higher. Additionally or alternately, MCFCs can be operated to provide electrical power at an operating voltage of 0.55 V to 0.80 V, or 0.55 V to 0.75 V, or 0.60 V to 0.80 V.

A second conventional use for MCFCs is for carbon capture. Often such MCFCs operated for carbon capture are also part of a power generation system, but in such conventional carbon capture situations, the power generation is a secondary factor. In such conventional carbon capture applications, the goal of operation for the MCFC is to maximize removal of CO₂ from flue gases and/or other CO₂-containing gases generated at a commercial site, such as a power plant or refinery. As a result, MCFCs operated for carbon capture are typically operated at CO₂ utilization values of 75% or more, or 80% or more, in order to reduce or minimize the amount of CO₂ released to the environment. Operating at low CO₂ utilization in a conventional carbon capture environment is therefore undesirable.

A third conventional use for MCFCs is hydrogen generation. In this type of application, an MCFC is operated at low fuel utilizations, so that excess hydrogen is available in the anode exhaust. When hydrogen generation is desired, operation at high fuel utilization would defeat the purpose for using the MCFCs.

### Definitions

Reformable Fuel: Reformable fuel is defined as any compound that contains sufficient amounts of hydrogen atoms and carbon atoms so that the compound can be at least partially converted in H₂ and carbon oxides under conditions suitable for hydrocarbon reforming. Alcohols are an example of non-hydrocarbon compounds that can also be reformed to produce at least H₂ and carbon oxides.

Fuel cell and fuel cell stack definitions: In this discussion, a fuel cell can correspond to a single cell, with an anode and a cathode separated by an electrolyte. The anode and cathode can receive input gas flows to facilitate the respective anode and cathode reactions for transporting charge across the electrolyte and generating electricity. A fuel cell stack can represent a plurality of cells in an integrated unit. Although a fuel cell stack can include multiple fuel cells, the fuel cells can typically be connected in parallel and can function (approximately) as if they collectively represented a single fuel cell of a larger size. When an input flow is delivered to the anode or cathode of a fuel cell stack, the fuel stack can include flow channels for dividing the input flow between each of the cells in the stack and flow channels for combining the output flows from the individual cells. In this discussion, a fuel cell array can be used to refer to a plurality of fuel cells (such as a plurality of fuel cell stacks) that are arranged in series, in parallel, or in any other convenient manner (e.g., in a combination of series and parallel). A fuel cell array can include one or more stages of fuel cells and/or fuel cell stacks, where the anode/cathode output from a first stage may serve as the anode/cathode input for a second stage. It is noted that the anodes in a fuel cell array do not have to be connected in the same way as the cathodes in the array. For convenience, the input to the first anode stage of a fuel cell array may be referred to as the anode input for the array, and the input to the first cathode stage of the fuel cell array may be referred to as the cathode input to the array. Similarly, the output from the final anode/cathode stage may be referred to as the anode/cathode output from the array.

It should be understood that reference to use of a fuel cell herein typically denotes a “fuel cell stack” composed of individual fuel cells, and more generally refers to use of one or more fuel cell stacks in fluid communication. Individual fuel cell elements (plates) can typically be “stacked” together in a rectangular array called a “fuel cell stack”. This fuel cell stack can typically take a feed stream and distribute reactants among all of the individual fuel cell elements and can then collect the products from each of these elements. When viewed as a unit, the fuel cell stack in operation can be taken as a whole even though composed of many (often tens or hundreds) of individual fuel cell elements. These individual fuel cell elements can typically have similar voltages (as the reactant and product concentrations are similar), and the total power output can result from the summation of all of the electrical currents in all of the cell elements, when the elements are electrically connected in series. Stacks can also be arranged in a series arrangement to produce high voltages. A parallel arrangement can boost the current. If a sufficiently large volume fuel cell stack is available to process a given exhaust flow, the systems and methods described herein can be used with a single molten carbonate fuel cell stack. In other aspects of the invention, a plurality of fuel cell stacks may be desirable or needed for a variety of reasons.

For the purposes of this invention, unless otherwise specified, the term “fuel cell” should be understood to also refer to and/or is defined as including a reference to a fuel cell stack composed of set of one or more individual fuel cell elements for which there is a single input and output, as that is the manner in which fuel cells are typically employed in practice. Similarly, the term fuel cells (plural), unless otherwise specified, should be understood to also refer to and/or is defined as including a plurality of separate fuel cell stacks. In other words, all references within this document, unless specifically noted, can refer interchangeably to the operation of a fuel cell stack as a “fuel cell”. For example, the volume of exhaust generated by a commercial scale combustion generator may be too large for processing by a fuel cell (i.e., a single stack) of conventional size. In order to process the full exhaust, a plurality of fuel cells (i.e., two or more separate fuel cells or fuel cell stacks) can be arranged in parallel, so that each fuel cell can process (roughly) an equal portion of the combustion exhaust. Although multiple fuel cells can be used, each fuel cell can typically be operated in a generally similar manner, given its (roughly) equal portion of the combustion exhaust.

It is noted that volume percentages of gas flows can be reported either on a “wet” basis, where all components in the gas flow are used to calculate volume percentages, or on a “dry” basis, where any water present in the gas flow is not considered when calculating volume percentages. In this discussion, unless otherwise specified, all volume percentages for gas flows are on a “wet” basis. It is understood that for a gas flow with no water content, the “wet” basis and “dry” basis values are identical.

### Molten Carbonate Fuel Cell Structure

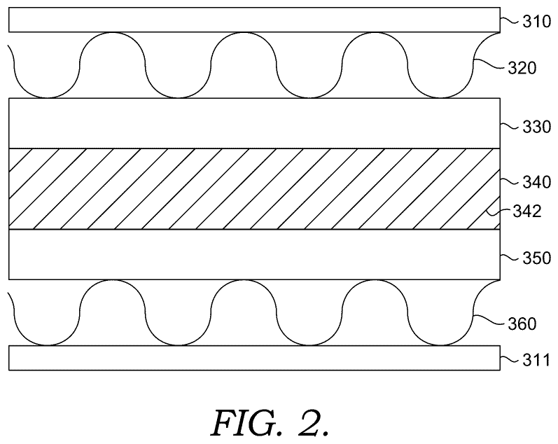

FIG. 2 shows a general example of a portion of a molten carbonate fuel cell stack which substantially corresponds to a single fuel cell. The portion of the stack shown in FIG. 2 corresponds to a fuel cell 301. In order to isolate the fuel cell from adjacent fuel cells in the stack and/or other elements in the stack, the fuel cell includes separator plates 310 and 311. In FIG. 2, the fuel cell 301 includes an anode 330 and a cathode 350 that are separated by an electrolyte matrix 340 that contains an electrolyte 342. In various aspects, cathode 350 can correspond to a dual-layer (or multi-layer) cathode. Anode collector 320 provides electrical contact between anode 330 and the other anodes in the stack, while cathode current collector 360 provides similar electrical contact between cathode 350 (via the structural mesh layer) and the other cathodes in the fuel cell stack. Additionally anode collector 320 allows for introduction and exhaust of gases from anode 330, while cathode current collector 360 allows for introduction and exhaust of gases from cathode 350. In some aspects, a structural mesh layer (not shown) can be disposed between cathode 350 and cathode current collector 360.

During operation, CO₂ is passed into the cathode current collector 360 along with O₂. The CO₂ and O₂ diffuse into the porous cathode 350 and travel to a cathode interface region near the boundary of cathode 350 and electrolyte matrix 340. In the cathode interface region, a portion of electrolyte 342 can be present in the pores of cathode 350. The CO₂ and O₂ can be converted near/in the cathode interface region to carbonate ion (CO₃²⁻), which can then be transported across electrolyte 342 (and therefore across electrolyte matrix 340) to facilitate generation of electrical current. After transport across the electrolyte 342, the carbonate ion can reach an anode interface region near the boundary of electrolyte matrix 340 and anode 330. The carbonate ion can be converted back to CO₂ and H₂O in the presence of H₂, releasing electrons that are used to form the current generated by the fuel cell. The H₂ and/or a hydrocarbon suitable for forming H₂ are introduced into anode 330 via anode collector 320.

In various aspects, the flow direction within the anode of a molten carbonate fuel cell can have any convenient orientation relative to the flow direction within a cathode. One option can be to use a co-current or counter-current flow configuration. Using co-current flow or counter-current flow can assist with providing higher uniformity in gas concentrations within a fuel cell. However, using co-current or counter-current flow can increase the complexity of the gas flow management. U.S. Patent Application Publication 2021/0159523 describes examples of how to manage the flows to a fuel cell when operated in co-current or counter-current mode.

Another option can be to use a cross-flow configuration, so that the flow direction within the anode is roughly at a 90° angle relative to the flow direction within the cathode. This type of flow configuration can have practical benefits, as using a cross-flow configuration can allow the manifolds and/or piping for the anode inlets/outlets to be located on different sides of a fuel cell stack from the manifolds and/or piping for the cathode inlets/outlets.

### Anode Inputs and Outputs

In various aspects, the anode input stream and/or the input stream to an external reformer associated with an MCFC can include hydrogen, a hydrocarbon such as methane, a hydrocarbonaceous or hydrocarbon-like compound that may contain heteroatoms different from C and H, or a combination thereof. The source of the hydrogen/hydrocarbon/hydrocarbon-like compounds can be referred to as a fuel source. In some aspects, most of the methane (or other hydrocarbon, hydrocarbonaceous, or hydrocarbon-like compound) fed to the anode and/or fed to an external reformer can typically be fresh methane. In this description, a fresh fuel such as fresh methane refers to a fuel that is not recycled from another fuel cell process. For example, methane recycled from the anode outlet stream back to the anode inlet may not be considered “fresh” methane, and can instead be described as reclaimed methane.

The fuel source used can be shared with other components, such as an engine or generator on a marine vessel, that uses a portion of the fuel source to provide a CO₂-containing stream for the cathode input. The fuel source input can include water in a proportion to the fuel appropriate for reforming the hydrocarbon (or hydrocarbon-like) compound in the reforming section that generates hydrogen. For example, if methane is the fuel input for reforming to generate H₂, the molar ratio of water to fuel can be from about one to one to about ten to one, such as at least about two to one. A ratio of four to one or greater is typical for external reforming, but lower values can be typical for internal reforming. To the degree that H₂ is a portion of the fuel source, in some optional aspects no additional water may be needed in the fuel, as the oxidation of H₂ at the anode can tend to produce H₂O that can be used for reforming the fuel. The fuel source can also optionally contain components incidental to the fuel source (e.g., a natural gas feed can contain some content of CO₂ as an additional component). For example, a natural gas feed can contain CO₂, N₂, and/or other inert (noble) gases as additional components. Optionally, in some aspects the fuel source may also contain CO, such as CO from a recycled portion of the anode exhaust. An additional or alternate potential source for CO in the fuel into a fuel cell assembly can be CO generated by steam reforming of a hydrocarbon fuel performed on the fuel prior to entering the fuel cell assembly.

More generally, a variety of types of fuel streams may be suitable for use as an anode input stream and/or the input stream for an external reformer associated with a molten carbonate fuel cell. Some fuel streams can correspond to streams containing hydrocarbons and/or hydrocarbon-like compounds that may also include heteroatoms different from C and H. Examples of hydrocarbon (including hydrocarbon-like) fuel streams include natural gas, streams containing C1-C4 carbon compounds (such as methane or ethane), and streams containing heavier C5+ hydrocarbons (including hydrocarbon-like compounds), as well as combinations thereof. Still other additional or alternate examples of potential fuel streams for use in an anode input can include biogas-type streams, such as methane produced from natural (biological) decomposition of organic material.

In some aspects, a molten carbonate fuel cell can be used to process an input fuel stream, such as a natural gas and/or hydrocarbon stream, with a low energy content due to the presence of diluent compounds. For example, some sources of methane and/or natural gas are sources that can include substantial amounts of either CO₂ or other inert molecules, such as nitrogen, argon, or helium. Due to the presence of elevated amounts of CO₂ and/or inerts, the energy content of a fuel stream based on the source can be reduced. Using a low energy content fuel for a combustion reaction (such as for powering a combustion-powered turbine) can pose difficulties. However, a molten carbonate fuel cell can generate power based on a low energy content fuel source with a reduced or minimal impact on the efficiency of the fuel cell. The presence of additional gas volume can require additional heat for raising the temperature of the fuel to the temperature for reforming and/or the anode reaction. Additionally, due to the equilibrium nature of the water gas shift reaction within a fuel cell anode, the presence of additional CO₂ can have an impact on the relative amounts of H₂ and CO present in the anode output. However, the inert compounds otherwise can have only a minimal direct impact on the reforming and anode reactions. The amount of CO₂ and/or inert compounds in a fuel stream for a molten carbonate fuel cell, when present, can be at least about 1 vol %, such as at least about 2 vol %, or at least about 5 vol %, or at least about 10 vol %, or at least about 15 vol %, or at least about 20 vol %, or at least about 25 vol %, or at least about 30 vol %, or at least about 35 vol %, or at least about 40 vol %, or at least about 45 vol %, or at least about 50 vol %, or at least about 75 vol %. Additionally or alternately, the amount of CO₂ and/or inert compounds in a fuel stream for a molten carbonate fuel cell can be about 90 vol % or less, such as about 75 vol % or less, or about 60 vol % or less, or about 50 vol % or less, or about 40 vol % or less, or about 35 vol % or less.

The output stream from an MCFC anode can include H₂O, CO₂, CO, and H₂. Optionally, the anode output stream could also have unreacted fuel (such as H₂ or CH₄) or inert compounds in the feed as additional output components. Instead of using this output stream as a fuel source to provide heat for a reforming reaction or as a combustion fuel for heating the cell, one or more separations can be performed on the anode output stream to separate the CO₂ from the components with potential value as inputs to another process, such as H₂ or CO. The H₂ and/or CO can be used as a syngas for chemical synthesis, as a source of hydrogen for chemical reaction, and/or as a fuel with reduced greenhouse gas emissions.

### Cathode Inputs and Outputs

Conventionally, a molten carbonate fuel cell can be operated based on drawing a desired load while consuming some portion of the fuel in the fuel stream delivered to the anode. The voltage of the fuel cell can then be determined by the load, fuel input to the anode, air and CO₂ provided to the cathode, and the internal resistances of the fuel cell. The CO₂ to the cathode can be conventionally provided in part by using the anode exhaust as at least a part of the cathode input stream. By contrast, the present invention can use separate/different sources for the anode input and cathode input. By removing any direct link between the composition of the anode input flow and the cathode input flow, additional options become available for operating the fuel cell, such as to generate excess synthesis gas, to improve capture of carbon dioxide, and/or to improve the total efficiency (electrical plus chemical power) of the fuel cell, among others.

In some aspects, the CO₂-containing stream for use as a cathode input flow can be based on the output or exhaust flow from a combustion source on a marine vessel. This can include any convenient type of combustion source on a marine vessel, such as the engines of the marine vessel and/or generators on the marine vessel for production of electricity. The type of combustion source and corresponding exhaust gas available on a marine vessel may vary depending on the type of vessel. For example, LNG ships for carrying liquefied natural gas may have engines and/or generators based on combustion of natural gas, resulting in a relatively low CO₂ concentration in the fuel gas produced by the engines and/or generators. By contrast, some larger vessels operate using heavy fuel oils as the fuel for engines, resulting in higher CO₂ contents in the resulting flue gas. Still other vessels can use marine gas oils, resulting in intermediate CO₂ contents in the flue gas. Additionally, generators on board a marine vessel may operate on a different fuel source than the engine. For example, marine vessels with engines that operate based on heavy fuel oils may use diesel generators to make electrical power.

Other examples of combustion sources include, but are not limited to, sources based on combustion of natural gas, combustion of coal, and/or combustion of other hydrocarbon-type fuels (including biologically derived fuels). Additional or alternate sources can include other types of boilers, fired heaters, furnaces, and/or other types of devices that burn carbon-containing fuels in order to heat another substance (such as water or air).

In some aspects, the CO₂ content of the cathode input stream can be 3.0 vol % to 20 vol %, or 3.0 vol % to 15 vol %, or 3.0 vol % to 10 vol %, or 3.0 vol % to 6.0 vol %, or 5.0 vol % to 20 vol %, or 5.0 vol % to 15 vol %, or 10 vol % to 20 vol %. In other aspects, such as some aspects where the cathode input stream is based on a flue gas from an LNG engine or another engine based on combustion of primarily C₁-C₄ hydrocarbons, the CO₂ content of the cathode input stream can be 5.0 vol % or less, or 4.0 vol % or less, such as 1.5 vol % to 5.0 vol %, or 1.5 vol % to 4.0 vol %, or 2.0 vol % to 5.0 vol %, or 2.0 vol % to 4.0 vol %.

Other potential sources for a cathode input stream can additionally or alternately include sources of bio-produced CO₂. This can include, for example, CO₂ generated by combustion of a bio-produced fuel, such as combustion of biodiesel or an at least partially bio-derived heavy fuel oil.

Yet another additional or alternate potential source of CO₂ can be CO₂-containing streams from a fuel cell. The CO₂-containing stream from a fuel cell can correspond to a cathode output stream from a different fuel cell, an anode output stream from a different fuel cell, a recycle stream from the cathode output to the cathode input of a fuel cell, and/or a recycle stream from an anode output to a cathode input of a fuel cell. For example, an MCFC operated in standalone mode under conventional conditions can generate a cathode exhaust with a CO₂ concentration of at least about 5 vol %. Such a CO₂-containing cathode exhaust could be used as a cathode input for an MCFC operated according to an aspect of the invention. More generally, other types of fuel cells that generate a CO₂ output from the cathode exhaust can additionally or alternately be used, as well as other types of CO₂-containing streams not generated by a “combustion” reaction and/or by a combustion-powered generator. Optionally but preferably, a CO₂-containing stream from another fuel cell can be from another molten carbonate fuel cell. For example, for molten carbonate fuel cells connected in series with respect to the cathodes, the output from the cathode for a first molten carbonate fuel cell can be used as the input to the cathode for a second molten carbonate fuel cell.

In addition to CO₂, a cathode input stream includes O₂ to provide the components necessary for the cathode reaction. Some cathode input streams can be based on having air as a component. For example, a combustion exhaust stream can be formed by combusting a hydrocarbon fuel in the presence of air. Such a combustion exhaust stream, or another type of cathode input stream having an oxygen content based on inclusion of air, can have an oxygen content of about 20 vol % or less, such as about 15 vol % or less, or about 10 vol % or less. Additionally or alternately, the oxygen content of the cathode input stream can be at least about 4 vol %, such as at least about 6 vol %, or at least about 8 vol %. More generally, a cathode input stream can have a suitable content of oxygen for performing the cathode reaction. In some aspects, this can correspond to an oxygen content of about 5 vol % to about 15 vol %, such as from about 7 vol % to about 9 vol %. For many types of cathode input streams, the combined amount of CO₂ and O₂ can correspond to less than about 21 vol % of the input stream, such as less than about 15 vol % of the stream or less than about 10 vol % of the stream. An air stream containing oxygen can be combined with a CO₂ source that has low oxygen content. For example, the exhaust stream generated by burning coal may include a low oxygen content that can be mixed with air to form a cathode inlet stream.

In addition to CO₂ and O₂, a cathode input stream can also be composed of inert/non-reactive species such as N₂, H₂O, and other typical oxidant (air) components. For example, for a cathode input derived from an exhaust from a combustion reaction, if air is used as part of the oxidant source for the combustion reaction, the exhaust gas can include typical components of air such as N₂, H₂O, and other compounds in minor amounts that are present in air. Depending on the nature of the fuel source for the combustion reaction, additional species present after combustion based on the fuel source may include one or more of H₂O, oxides of nitrogen (NOx) and/or sulfur (SOx), and other compounds either present in the fuel and/or that are partial or complete combustion products of compounds present in the fuel, such as CO. These species may be present in amounts that do not poison the cathode catalyst surfaces though they may reduce the overall cathode activity. Such reductions in performance may be acceptable, or species that interact with the cathode catalyst may be reduced to acceptable levels by known pollutant removal technologies.

The amount of O₂ present in a cathode input stream (such as an input cathode stream based on a combustion exhaust) can advantageously be sufficient to provide the oxygen needed for the cathode reaction in the fuel cell. Thus, the volume percentage of O₂ can advantageously be at least 0.5 times the amount of CO₂ in the exhaust. Optionally, as necessary, additional air can be added to the cathode input to provide sufficient oxidant for the cathode reaction. When some form of air is used as the oxidant, the amount of N₂ in the cathode exhaust can be at least about 78 vol %, e.g., at least about 88 vol %, and/or about 95 vol % or less. In some aspects, the cathode input stream can additionally or alternately contain compounds that are generally viewed as contaminants, such as H₂S or NH₃. In other aspects, the cathode input stream can be cleaned to reduce or minimize the content of such contaminants. In various aspects, the O₂ content of the cathode input stream can be 1.5 vol % or more, or 3.0 vol % or more, or 5.0 vol % or more, such as up to 20 vol % or possibly still higher.

A suitable temperature for operation of an MCFC can be between about 450° C. and about 750° C., such as at least about 500° C., e.g., with a cathode inlet temperature of about 550° C. and a cathode outlet temperature of about 625° C. Prior to entering the cathode, heat can be added to or removed from the cathode input stream, if desired, e.g., to provide heat for other processes, such as reforming the fuel input for the anode. For example, if the source for the cathode input stream is a combustion exhaust stream, the combustion exhaust stream may have a temperature greater than a desired temperature for the cathode inlet. In such an aspect, heat can be removed from the combustion exhaust prior to use as the cathode input stream. Alternatively, the combustion exhaust could be at very low temperature, for example after a wet gas scrubber on a coal-fired boiler, in which case the combustion exhaust can be below about 100° C. Alternatively, the combustion exhaust could be from the exhaust of a gas turbine operated in combined cycle mode, in which the gas can be cooled by raising steam to run a steam turbine for additional power generation. In this case, the gas can be below about 50° C. Heat can be added to a combustion exhaust that is cooler than desired.

### Configuration Example

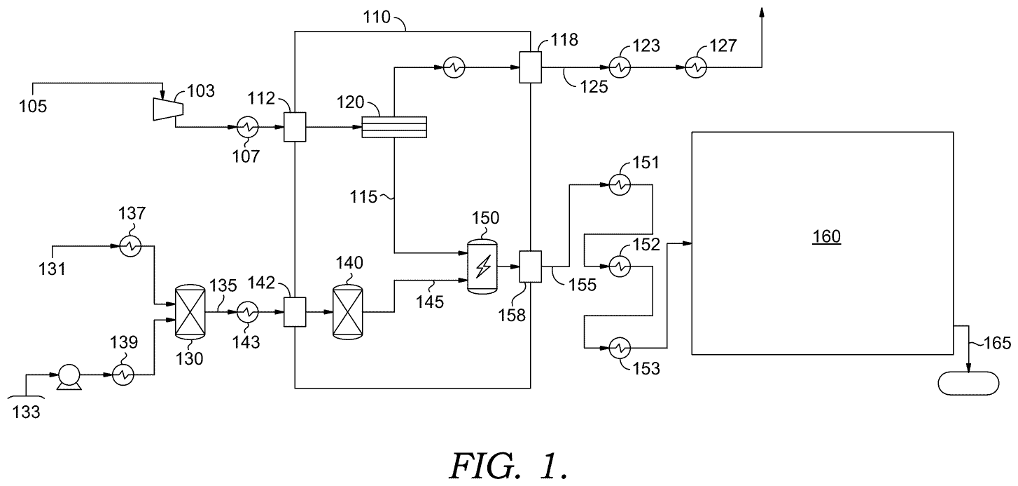

FIG. 1 shows an example of a configuration for using molten carbonate fuel cells in a marine vessel environment. In this type of configuration, molten carbonate fuel cells can allow for carbon capture with a reduced or minimized equipment footprint. The reduced or minimized footprint can include any equipment footprint that is saved by using electricity from the molten carbonate fuel cells in place of additional diesel generators on a marine vessel.

In the example configuration shown in FIG. 1, a system and process flow for a using one or more molten carbonate fuel cell stacks 110 in a marine vessel environment is illustrated. In FIG. 1, CO₂-containing gas 105 can correspond to any portion of the CO₂-containing gases (such as flue gases) generated on a marine vessel. This can include, but is not limited to, flue gases generated by the engines for the marine vessel, flue gases formed by generators used for providing electrical power, flue gases from other combustion sources, and/or or CO₂-containing gases from any other source on the vessel. In some aspects, CO₂-containing gas 105 can correspond to a portion of the total flue gases generated by the engines for the marine vessel. In aspects where CO₂-containing gas 105 corresponds to exhaust (flue gas) from an engine, the CO₂ content of the gas flow can generally be between 3.5 vol % and 8.0 vol %, the temperature of the gas flow can be between 100° C. and 400° C., and the pressure can be near 100 kPa-a.

In the configuration shown in FIG. 1, CO₂-containing gas 105 is optionally passed through a blower 103 or other device for increasing gas pressure prior to entering the MCFC stack 110, such as increasing the pressure from roughly 100 kPa-a to between 150 kPa-a and 600 kPa-a. In the configuration shown in FIG. 1, CO₂-containing gas 105 is optionally passed through a heat exchanger 107 and/or other heating device in order to increase the temperature of CO₂-containing gas to a temperature closer to the operating temperature of the MCFC stack 110. Typically a flue gas from an engine or a generator can be at a temperature of less than 400° C. Such gases can be heated to a temperature between 500° C. and 625° C. prior to entering the fuel cell stack, in order to assist with maintaining the temperature of the fuel cell stack. The CO₂-containing gas 105 is then passed into a cathode inlet 112 of fuel cell stack 110 for processing in cathode 120.

For the anode input flow, in the example shown in FIG. 1, propane 131 is used as the initial hydrocarbon source. However, any convenient type of hydrocarbon that is suitable for passing into a steam reformer can be used, such as diesel fuel or LNG. In some aspects, if natural gas and/or methane is available, reforming prior to passing the fuel into the fuel cell stack 110 may not be needed. Propane 131 (and/or other reformable hydrocarbon) and water 133 are passed into optional reforming stage 130 to reform at least a portion of the propane (or other hydrocarbon) into H₂, H₂O, CH₄, CO₂, and optionally CO. The reforming can be performed under conventional steam reforming conditions. For example, the input flow to reforming can be heated to a temperature between 400° C. and 500° C., and the reformed output can be at a temperature between 350° C. and 450° C. Optionally, an alternative type of reforming, such as an autothermal reforming, can be used instead of and/or in addition to a steam reforming. The at least partially reformed fuel flow 142 is optionally further heated 143 prior to passing the at least partially reformed fuel flow 142 into an anode inlet 142 for processing within fuel cell stack 100. For example, the partially reformed fuel flow can be heated to 500° C. to 625° C. prior to entering the fuel cell stack.

In fuel cell stack 100, the gas flow entering cathode inlet 112 is passed into cathode 120. In cathode 120, CO₂ and O₂ are converted into carbonate ions, which are then transported 115 from cathode 120 across the electrolyte matrix into anode 150. Only a portion of the CO₂ is converted in this manner. The remaining CO₂ leaves fuel cell stack 100 from a cathode outlet 118 as a cathode exhaust 125. The cathode exhaust 125 can optionally be used for heat exchange 123 and/or 127 (such as to provide heat for heating the cathode input flow stream or the anode input flow stream) prior to exiting from the system. It is noted that other components in the gas flow entering the cathode, such as nitrogen oxides, can also be converted into ions for transport 115 across the electrolyte into anode 150.

In fuel cell stack 100, the at least partially reformed fuel flow 142 can optionally undergo further reforming in an internal reforming stage 140. This can create additional H₂ in twice-reformed fuel flow 145, thus reducing the amount of reforming that is performed in anode 150. In anode 150, H₂ is reacted with carbonate that was transported 115 across the electrolyte to form CO₂ and H₂O while also generating electrical power. This results in formation of a high CO₂-content anode exhaust 155 that exits from fuel cell stack 110 via an anode outlet 158. It is noted that nitrogen oxides transported 115 across the electrolyte can also be converted into nitrogen within the anode. The anode exhaust 155 can optionally undergo one or more heat exchange processes 151, 152, and/or 153 prior to entering a separation stage 160 for removing at least a portion of the water from the anode exhaust. The resulting water-depleted exhaust stream 165, which may include some water (typically less than 0.5 vol %) as well as some unreacted H₂, is then stored on the marine vessel.

The cathodes, anodes, and optional reforming stages within a fuel cell stack can be operated at convenient temperatures for operating a molten carbonate fuel cell, such as temperatures between 550° C. and 700° C. The output flows from the fuel cell stack can typically be hotter than the input flows, so that the output flows are at a temperature of 550° C. to 700° C. prior to any heat exchange or other cooling.

It is noted that a configuration such as the example configuration shown in FIG. 1 can provide various opportunities for heat integration. The streams entering the molten carbonate fuel cell stack 110 are generally heated prior to entry, and the output flows exiting from the fuel cell stack are generally at higher temperatures than the input flows. Thus, the output flows from the fuel cell stack can potentially be used for heat exchange with the input flows to mitigate the energy requirements for heating input flows to target temperatures for entry into the fuel cell stack.

### EXAMPLES

A process model was developed based on experimental data to allow for comparison of configurations using MCFCs on a marine vessel for CO₂ mitigation with other types of configurations. In this model, a mid-size marine tanker was assessed which uses a 15.7 MW propulsion heavy fuel oil engine, in addition to three 1 MW diesel generators for electrical power on board. This is a typical configuration of a SuezMax tanker. In an initial set of simulations, capture of roughly 50% of the CO₂ generated by the marine vessel was modeled.

In the process model for MCFC carbon capture at 50%, the results demonstrate that the process generates excess heat and power, ˜4 MW and ˜2 MW, respectively. The fuel for the MCFC in the model was propane, but can be envisioned to be any fuel (e.g. natural gas, LPG, etc.). All of the heat and power required to operate the MCFC carbon capture devise is generated by MCFC operation; the additional power enables two diesel generators to be eliminated. This provides additional advantages besides carbon capture.

The assumptions that went into the process model are the following: The fuel utilization (Uf) for the MCFC was 95%. The steam/propane fuel ratio was 6:1 (mol/mol), to enable complete conversion to H₂ and CO₂. Complete water gas-shift occurs. The MCFC transference percent is 100%. The 15.7 MW propulsion engine has an efficiency of 48%, and the diesel generators have an efficiency of 44%. The heavy fuel oil has a carbon content of 87 wt %. The propulsion engine exhaust gas has a CO₂ concentration of ˜4 mol %. Propane is the fuel for the fuel cell, which undergoes reforming with H₂O. Fuel cell power was estimated at 160 mA/cm² and an average cell voltage of 700 mV. While the assumptions above were used in these process models, the operating envelope of the MCFC technology is expected to be broad.

As a comparison, a 2021 joint report by OGCI and Stena Bulk titled “Is Carbon Capture on Ships Feasible?”, provides estimates of the requirements for implementing aqueous amine capture technology on a marine vessel. Based on the values from that report, the process model was expanded to allow for comparison of the aqueous amine technology. Based on the model and the report, the aqueous amine technology requires excess power. For 50% capture, the amine process will require 22% excess fuel for the propulsion engine, which equates to ˜18% excess fuel total. Comparatively, MCFC technology that captures 50% of the propulsion engine CO₂ emissions only requires ˜2.4% excess fuel. The main reasons for this are: 1) The generation of power (˜4 MW total, ˜2 MW excess) by the fuel cell allows for the elimination of two diesel generators; and 2) The efficiency of the fuel cell is greater than that of the diesel generators (˜63% compared to 44%, respectively).

Additional process models were developed for MCFC carbon capture for marine applications at a total CO₂ capture rate of 50%, which thereby requires 47% capture of the propulsion engine exhaust effluent, and a 70% propulsion engine capture rate, which gives a total carbon capture (CC) rate of 75%.

A comparison of the MCFC process models for CC, compared to the marine case with no CC and with amines at 50% CC are shown in Table 1. As shown in Table 1, using MCFCs for carbon capture in a marine vessel environment can provide a variety of advantages.

TABLE 1
CO₂ Capture Process Model Results

| | | No | Amine | Fuel Cell | Fuel Cell | Fuel Cell |
|---|---|---|---|---|---|---|
| | | Capture | 50% CC | 47% CC | 50% CC | 70% CC |
| Total CO₂ Produced | t/hr | 11.1 | 13.1 | 11.3 | 11.2 | 11.2 |
| Total CO₂ Captured | t/hr | — | 6.5 | 5.7 | 6.0 | 8.4 |
| Total CO₂ Exhausted | t/hr | 11.1 | 6.5 | 5.7 | 5.2 | 2.7 |
| Total CO₂ Capture Percent | % | — | 50 | 50 | 54 | 75 |
| CO₂ Avoided | % | — | 41 | 49 | 53 | 75 |
| Total Fuel Efficiency | % | 47 | 47 | 50 | 50 | 51 |
| CO₂ Avoided Compared to | % | — | — | 19 | 29 | 84 |
| Amine Case | | | | | | |
| Excess Fuel required | % | 0.0 | 18.2 | 3.3 | 2.4 | 2.2 |
| CO₂ emitted/Fuel LHV | t/MWhr | 0.280 | 0.140 | 0.137 | 0.127 | 0.066 |
| Energy | | | | | | |
| Fuel Cell Modules | # | — | — | 7 | 8 | 11 |
| Required | | | | | | |

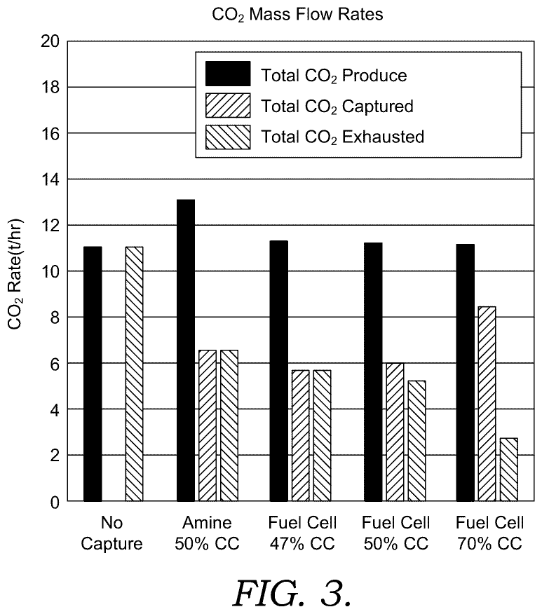

As shown in Table 1, one advantage of using MCFCs rather than an amine capture system is that the total CO₂ production with the amine case is greater by ˜2 t/hr because the amine system requires excess power to run. Thus, more fuel is required, as the amine process only consumes power. In contrast, the MCFC process also generates power as it captures CO₂, thus reducing or minimizing the total system fuel requirements, as the power generated by the MCFCs can replace the need for some of the diesel generators. The CO₂ production, capture, and exhaust rates are shown in FIG. 3, and are listed in Table 1. It is noted that in FIG. 3, the amount of CO₂ captured and CO₂ exhausted is equal in the cases where amines are used for capture of 50% of the CO₂ from the engines, while for MCFCs at 50% capture from the engine flue gas, the amount of CO₂ exhausted is lower than the amount of CO₂ captured. This is due to the fact that when MCFCs are used, the MCFCs provide part of the power and also generate part of the CO₂. The CO₂ generated by the MCFCs is in the anode exhaust, so it is also captured, thus increasing the total amount of CO₂ captured. Thus, for a system including MCFCs, only 47% capture of CO₂ from the marine vessel engines is required to achieve a total CO₂ capture of 50%, as substantially all of the CO₂ produced from the fuel cell fuel is captured.

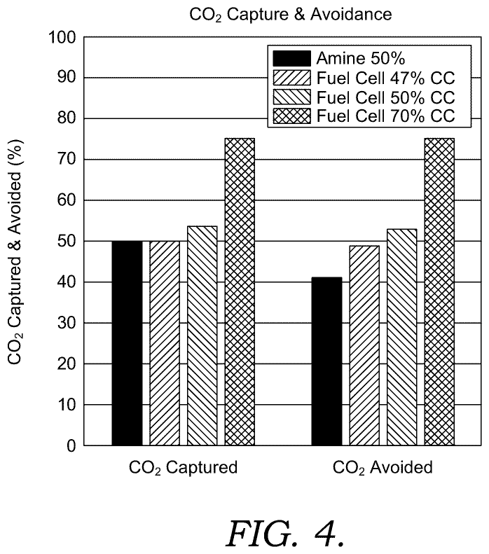

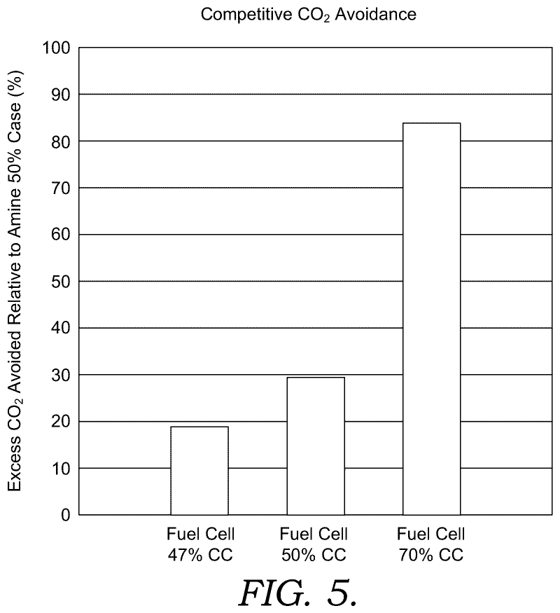

Another advantage is that using MCFCs for carbon capture can avoid the generation of some CO₂. The CO₂ avoided, calculated as [1−(CO₂ exhausted/CO₂ exhaust with no carbon capture)], shows significant advantage when using MCFC technology. The CO₂ capture and avoidance metrics are shown in FIG. 4, relative to the marine application with no carbon capture (CC). Furthermore, when comparing MCFC technology to amine technology, at 50% CC, MCFC technology has ˜29% greater CO₂ avoided, as shown in FIG. 5.

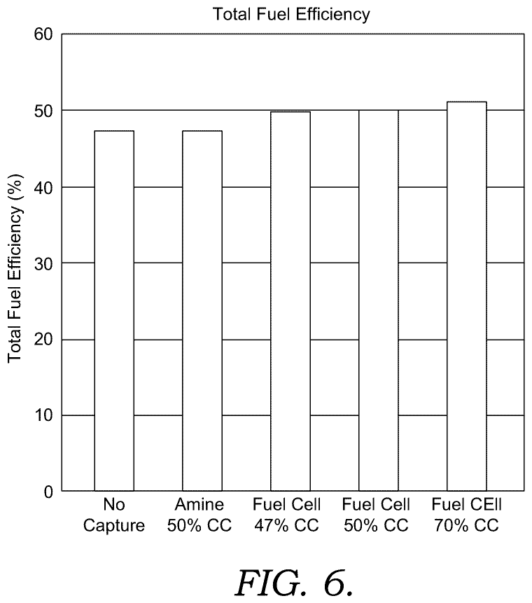

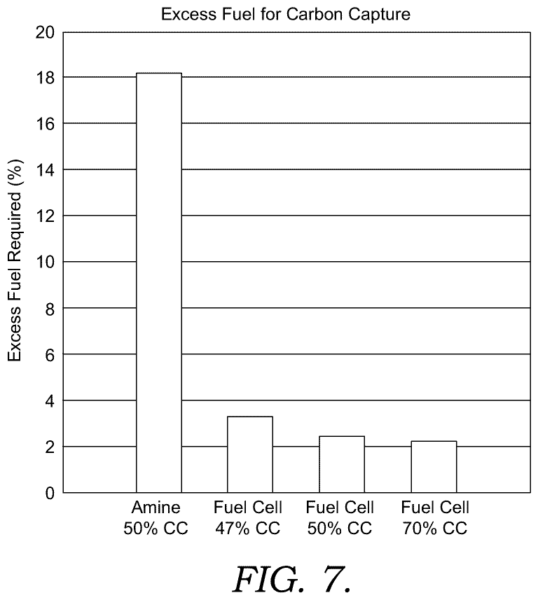

Still another advantage is that MCFCs have better fuel efficiency than the diesel generators, and therefore the overall fuel efficiency for MCFC technology is improved, relative to no capture cases and the amine technology process (FIG. 6). Relative to the no capture cases, amine technology requires ˜18-22% excess fuel, while MCFC technology requires <4% excess fuel (FIG. 7). Furthermore, higher carbon capture rates (e.g. 70% compared to 50%) for MCFC technology can provide still further advantages, due to the ability to eliminate the need for any diesel generators, as the 70% cases generates ˜5.5 MW of power (˜3 MW excess power). This also provides a capital cost advantage.

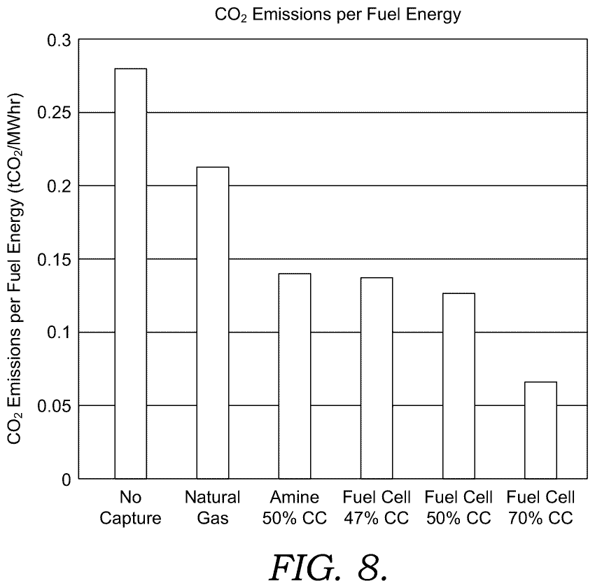

Finally, when assessed on a CO₂ emitted per fuel energy basis, MCFC shows an advantage as well. As shown in FIG. 8, for the MCFCs, the CO₂ emitted per unit of fuel energy decreases as the amount of captured carbon increases. It is noted that the 47% capture case for the MCFC is comparable to the 50% capture case for the amine capture system. Thus, for equivalent amounts of removal of CO₂ from the engine flue gases, the MCFC system allows for lower CO₂ emissions per amount of fuel energy that is used.

In addition to the carbon capture advantages, using MCFCs in a marine environment can provide other types of advantages. For example, MCFC technology produces H₂O on-board, which can allow additional energy savings to remove or decrease requirement for desalination, hence further reducing GHG emissions onboard. As another examples, MCFCs do not require large amine tanks, and the associated costs, hazards, and risks with bunkering, storing, and handling these chemicals. Still another advantage is that an MCFC is a solid-state system, so it is not sensitive to sway motion due to wind or current, unlike an amine system.

While the process model developed was for a mid-size tanker, MCFC technology can be used of other marine applications, including LNG (liquefied natural gas) ships, CO₂ transport ships, container ships and bulk carriers, and others. It is noted that using MCFCs can provide still further advantages for LNG ships. For example, the LNG exhaust is hotter than a tanker that uses a heavy fuel oil, and this is an improvement as less heat is required prior to entering the MCFC technology. Furthermore the LNG fuel on-board can be used as the fuel for the MCFC, rather than the need to have a separate MCFC fuel. LNG exhaust also contains trace amounts of methane, and the MCFC technology will convert that to CO₂ in-situ, addressing methane slip issues from LNG engines.

### ADDITIONAL EMBODIMENTS

Embodiment 1. A method for operating a molten carbonate fuel cell, comprising: providing a cathode input flow comprising 3.0 vol % or more CO₂ and at least 1.5 vol % O₂ to a cathode of a molten carbonate fuel cell; providing an anode input flow comprising H₂, reformable hydrocarbons, or a combination thereof to an anode of the molten carbonate fuel cell; operating the molten carbonate fuel cell at a CO₂ utilization of 70% or less, a fuel utilization of 80% or more, and a current density of 100 mA/cm² or more to generate electrical power and to produce a cathode output flow and an anode output flow.

Embodiment 2. The method of Embodiment 1, wherein the CO₂ utilization is 60% or less.

Embodiment 3. The method of any of the above embodiments, wherein the CO₂ utilization is 55% or less.

Embodiment 4. The method of any of the above embodiments, wherein the fuel utilization is 90% or more.

Embodiment 5. The method of any of the above embodiments, wherein the anode output flow comprises 0.5 vol % or less of reformable hydrocarbons, or wherein the anode output flow comprises 1.0 vol % or less of H₂, or a combination thereof.

Embodiment 6. The method of any of the above embodiments, wherein the cathode output flow comprise a CO₂ content of 2.0 vol % or more.

Embodiment 7. The method of any of the above embodiments, wherein the anode output flow comprises 0.1 vol % or less of CH₄, 2.5 vol % or less of H₂, and 1.0 vol % or less of CO.

Embodiment 8. The method of any of the above embodiments, wherein providing the cathode input flow comprises: performing a combustion reaction to form a combustion flue gas comprising 4.0 vol % or more of CO₂, wherein the cathode input flow comprises 70% or less of the combustion flue gas.

Embodiment 9. The method of Embodiment 8, wherein the cathode input flow comprises 60% or less of the combustion flue gas.

Embodiment 10. The method of Embodiment 8 or 9, wherein the combustion flue gas comprises a combustion flue gas generated by an engine of a marine vessel, and wherein a portion of the reformable hydrocarbons in the anode input flow comprise a fuel for the engine of the marine vessel.

Embodiment 11. The method of any of the above embodiments, wherein the reformable fuel comprises at least one of methane and natural gas.

Embodiment 12. The method of any of the above embodiments, further comprising reforming diesel fuel in a reforming stage to produce a reforming effluent comprising H₂ and reformable fuel, wherein the anode input flow comprises at least a portion of the reforming effluent.

Embodiment 13. The method of any of the above embodiments, wherein the molten carbonate fuel cell is operated on a marine vessel, the method further comprising storing at least a portion of the anode output flow on the marine vessel.

Embodiment 14. The method of any of the above embodiments, wherein the cathode input flow further comprises 0.01 vol % to 0.5 vol % of nitrogen oxides, and a) wherein 40 wt % or more of the nitrogen oxides in the cathode input flow are transferred to the anode output flow, b) wherein the cathode output flow comprises less than 0.01 vol % of nitrogen oxides, or c) a combination thereof.

Embodiment 15. The method of any of the above embodiments, wherein the cathode input flow further comprises 0.005 vol % to 0.1 vol % of hydrocarbons, and wherein the cathode output flow contains less than 0.005 vol % of hydrocarbons.

Additional Embodiment A. The method of any of the above embodiments, wherein the molten carbonate fuel cell is operated at an operating voltage of 0.55 V to 0.80 V.

Additional Embodiment B. The method of any of Embodiments 1-3 or 5-15, wherein the fuel utilization is 90% or more.

All numerical values within the detailed description and the claims herein are modified by “about” or “approximately” the indicated value, and take into account experimental error and variations that would be expected by a person having ordinary skill in the art.

Although the present invention has been described in terms of specific embodiments, it is not necessarily so limited. Suitable alterations/modifications for operation under specific conditions should be apparent to those skilled in the art. It is therefore intended that the following claims be interpreted as covering all such alterations/modifications that fall within the true spirit/scope of the invention.

What is claimed is:

1. A method for operating a molten carbonate fuel cell, comprising:
providing a cathode input flow comprising 3.0 vol % or more CO₂ and at least 1.5 vol % O₂ to a cathode of a molten carbonate fuel cell;
providing an anode input flow comprising H₂, reformable hydrocarbons, or a combination thereof to an anode of the molten carbonate fuel cell;
operating the molten carbonate fuel cell at a CO₂ utilization of 70% or less, a fuel utilization of 80% or more, and a current density of 100 mA/cm² or more to generate electrical power and to produce a cathode output flow and an anode output flow.

2. The method of claim 1, wherein the CO₂ utilization is 60% or less.

3. The method of claim 1, wherein the CO₂ utilization is 55% or less.

4. The method of claim 1, wherein the fuel utilization is 85% or more.

5. The method of claim 1, wherein the fuel utilization is 90% or more.

6. The method of claim 1, wherein the anode output flow comprises 0.5 vol % or less of reformable hydrocarbons, or wherein the anode output flow comprises 1.0 vol % or less of H₂, or a combination thereof.

7. The method of claim 1, wherein the cathode output flow comprise a CO₂ content of 2.0 vol % or more.

8. The method of claim 1, wherein the anode output flow comprises 0.1 vol % or less of CH₄, 2.5 vol % or less of H₂, and 1.0 vol % or less of CO.

9. The method of claim 1, wherein providing the cathode input flow comprises:
performing a combustion reaction to form a combustion flue gas comprising 4.0 vol % or more of CO₂, wherein the cathode input flow comprises 70% or less of the combustion flue gas.

10. The method of claim 9, wherein the cathode input flow comprises 60% or less of the combustion flue gas.

11. The method of claim 9, wherein the combustion flue gas comprises a combustion flue gas generated by an engine of a marine vessel, and wherein a portion of the reformable hydrocarbons in the anode input flow comprise a fuel for the engine of the marine vessel.

12. The method of claim 1, wherein the reformable fuel comprises at least one of methane and natural gas.

13. The method of claim 1, further comprising reforming diesel fuel in a reforming stage to produce a reforming effluent comprising H₂ and reformable fuel, wherein the anode input flow comprises at least a portion of the reforming effluent.

14. The method of claim 1, wherein the molten carbonate fuel cell is operated on a marine vessel, the method further comprising storing at least a portion of the anode output flow on the marine vessel.

15. The method of claim 1, wherein the molten carbonate fuel cell is operated at an operating voltage of 0.55 V to 0.80 V.

16. The method of claim 1, wherein the cathode input flow further comprises 0.01 vol % to 0.5 vol % of nitrogen oxides, and wherein 40 wt % or more of the nitrogen oxides in the cathode input flow are transferred to the anode output flow.

17. The method of claim 1, wherein the cathode input flow further comprises 0.005 vol % to 0.1 vol % of hydrocarbons, and wherein the cathode output flow contains less than 0.005 vol % of hydrocarbons.

18. A method for operating a molten carbonate fuel cell, comprising:
providing a cathode input flow comprising 3.0 vol % or more CO₂ and at least 1.5 vol % O₂ to a cathode of a molten carbonate fuel cell;
providing an anode input flow comprising H₂, reformable hydrocarbons, or a combination thereof to an anode of the molten carbonate fuel cell;
operating the molten carbonate fuel cell at a CO₂ utilization of 70% or less, a fuel utilization of 90% or more, and a current density of 100 mA/cm² or more to generate electrical power and to produce a cathode output flow and an anode output flow.

19. A method for operating a molten carbonate fuel cell, comprising:
providing a cathode input flow comprising 3.0 vol % or more CO₂, at least 1.5 vol % O₂, and
i) 0.01 vol % to 0.5 vol % nitrogen oxides,
ii) 0.005 vol % to 0.1 vol % of hydrocarbons, or
iii) a combination of i) and ii)
to a cathode of a molten carbonate fuel cell;
providing an anode input flow comprising H₂, reformable hydrocarbons, or a combination thereof to an anode of the molten carbonate fuel cell;
operating the molten carbonate fuel cell at a CO₂ utilization of 70% or less, a fuel utilization of 80% or more, and a current density of 100 mA/cm² or more to generate electrical power and to produce a cathode output flow and an anode output flow, the cathode output flow comprising less than 0.01 vol % of nitrogen oxides and less than 0.005 vol % of hydrocarbons.

20. The method of claim 19, wherein 40 wt % or more of the nitrogen oxides in the cathode input flow are transferred to the anode output flow.
